(19) United States
(12) Patent Application Publication
(10) Pub. No.: US 2004/0217666 A1
(43) Pub. Date: Nov. 4, 2004

(54) Rotor assembly of synchronous machine

(75) Inventors: Philip H. Mellor, Bristol (GB); Timothy J. Allen, Cotham (GB); David Seniawski, Palo Alto, CA (US); Raymond Ong, Novi, MI (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Ballard Power Systems Corporation, Dearborn, MI (US)

(21) Appl. No.: 10/730,759

(22) Filed: Dec. 8, 2003

Related U.S. Application Data
(60) Provisional application No. 60/432,727, filed on Dec. 11, 2002.

(51) Int. Cl. H02K 21/12; H02K 1/27

(52) U.S. Cl. 310/156.53

(57) ABSTRACT

Methods and systems for use with an electric machine which reduce magnetic leakage paths, improve d-axis flux, and/or reduce stress levels at high operating speeds.

### BACKGROUND OF THE INVENTION

1. Technical Field

The present systems and methods relate generally to electric machines, for example, electric motor and generators.

2. Description of the Related Art

Electric machines, such as electric motors and generators, are used in many applications, including those ranging from electric vehicles to domestic appliances. Improvements in electric machine performance, reliability, efficiency, and power density for all types of electric machines are desired.

Rotors for electric machines of the type having permanent magnets disposed within slots within a lamination stack require secure containment of the magnets to prevent the magnets from moving during the operation of the electric machine. With regard to conventionally designed rotors in which permanent magnets are mounted on the outer surface of the rotor, there are several traditional arrangements for containment that prevent the magnets from being thrown off the rotor by centrifugal forces produced as a result of motor operation. Presently used forms of containment include non-magnetic structures mounted or formed on the outer surface of the rotor. The use of outer disposed containment structures requires substantial additional manufacturing steps beyond stamping rotor laminations and stacking them to form a rotor core, such as attaching the conventional structures to the rotor core.

Conventional assemblies in which the permanent magnets are mounted within the rotor core, which is made of a magnetic material, create a problem of leakage of magnetic flux from the permanent magnet that causes a corresponding loss in the efficiency of the electric machine. Flux leakage occurs when lines of flux from one pole of the magnet pass through the rotor material located between the permanent magnet and stator, to the other pole of the permanent magnet without crossing the air gap and passing through the stator. In applications in which the motor is running frequently, flux leakage losses are of a significant concern and constitute a substantial portion of overall motor inefficiency. Another source of efficiency loss for electric machines in which permanent magnets are disposed within the rotor core is caused by having a relatively large amount of magnetic rotor material disposed between the permanent magnet and the stator. This varies in width across the outwardly facing surface of the permanent magnet. Conventional rotor assemblies include rectangularly shaped rotor slots in which the permanent magnets are disposed. In these conventional rotor assemblies, stress concentration increases with high operating speeds. When the rotor rotates at high speeds, the permanent magnets exert an outward force on the outer wall of the rotor slot, which results in stress forces being concentrated at the rectangularly shaped slot outer corners. The high stress levels in conventional rotor assemblies result in a reduction in the mechanical strength of the rotor stack.

Electric machines may also experience vibrations caused by torque pulsations. The problem is particularly acute in the context of variable speed motors which are operated over a wide range of speeds. The frequency of the vibrations changes with the speed of the motor, and the vibrations may be transmitted from the rotor to the permanent magnets. The vibrations may result in the permanent magnets shifting during the operation of the electric machine which may result in damage to the permanent magnets and ultimately lead to the decreased performance and efficiency of the electric machine.

Thus, there is a need for a rotor assembly for a synchronous electric machine that is designed to reduce the magnetic leakage and improve the d-axis flux. Further, there is a need for a rotor assembly that is designed to reduce the stress levels in the rotor core during high speed electric machine operation. The greater the reduction of magnetic leakage and the better the physical condition of the rotor core, the more efficient and reliable the electric machine will be.

### BRIEF SUMMARY OF THE INVENTION

The present systems and methods provide an assembly for reducing the magnetic leakage path from the permanent magnets through the rotor material. The present systems and methods may further improve d-axis flux. The slot design of the rotor assembly of the present systems and methods may result in a reduction in the stress levels of the rotor stack at high operating speeds. The present systems and methods may provide a rotor lamination which facilitates the retention of a permanent magnet within a rotor core. In one embodiment, the rotor lamination inhibits flux leakage in the rotor core.

In one embodiment, an electric machine assembly provides a rotor having a center axis. In another embodiment, the rotor is formed by a plurality of substantially round-shaped lamination layers that are axially stacked along the center axis of the rotor. In another embodiment, each of the lamination layers has at least one internal slot that has an elongate portion that is preferably trapezoidal in shape (e.g., rectangular), expanded or bulbous end regions that may exemplarily take the form of bulbous shaped portions disposed at both ends of the trapezoidal shaped (e.g., rectangular shaped) portion, and at least one notch disposed on either of the elongate sides of the trapezoidal shaped portion.

In another embodiment, the internal slot is designed to receive a permanent magnet. In another embodiment, once a permanent magnet is received in the slot, a nonmagnetic wedge is inserted on at least one side of the magnet. In another embodiment, at least one of the notches is made operable for exerting a wedging force on the permanent magnet and preventing it from moving within the internal slot.

In another embodiment, filler may be inserted into the bulbous shaped portion of the internal slot. The filler can include air, epoxy, resin, and/or adhesive in various embodiments.

In another embodiment, the bulbous shaped portion of the internal slot is constructed to be operable for reducing the magnetic leakage from the permanent magnet through rotor material located between the permanent magnet and a stator. In another embodiment, the bulbous shaped portion is further operable for improving d-axis flux. In another embodiment, the bulbous shaped portion is further operable for reducing stress levels exerted upon the rotor material located between the permanent magnet and the stator.

In one embodiment, the present systems and methods provide a method for fixably disposing a permanent magnet into a rotor assembly of an electric machine. In another embodiment, the method includes disposing a permanent magnet into a slot of a rotor stack in which the slot includes a trapezoidal shaped (e.g., rectangular shaped) portion and bulbous shaped portions disposed at both ends of the trapezoidal shaped portion. In another embodiment, at least one notch is disposed at the points where the trapezoidal shaped portion and the bulbous shaped portions meet.

In another embodiment, after the permanent magnet is received (installed in) by the slot, a non-magnetic wedge-shaped member is inserted on at least one side of the permanent magnet. In another embodiment, the non-magnetic wedge is operable for exerting an outwardly perpendicular wedging force on the permanent magnet that holds the permanent magnet in place. In another embodiment, at least one of the notches is operable for exerting a wedging force on the permanent magnet and preventing it from moving within the slot.

In one embodiment, the present systems and methods provide a rotor for a synchronous machine that includes a shaft, a plurality of permanent magnets disposed around the shaft at generally equal spacings or intervals. In another embodiment, a rotor core is disposed around the shaft and is formed by axially stacking and joining a plurality of core laminations. In another embodiment, a plurality of rotor slots are provided and configured to be operable for receiving the permanent magnets. As described above, a filler is then disposed within portions of the rotor slots about the permanent magnets.

As outlined with respect to other described embodiments, the rotor slots may each have a trapezoidal shaped portion with bulbous shaped portions disposed at both ends thereof. In some embodiments, there is also at least one notch disposed at the interface between where the trapezoidal shaped portion and the bulbous shaped portions meet one another. Similarly, in some embodiments, non-magnetic wedge members are also provided in the slots adjacent to the permanent magnets

In one embodiment, the rotor for the synchronous machine includes at least one non-magnetic wedge disposed within the plurality of rotor slots and adjacent to the plurality of permanent magnets. In another embodiment, the non-magnetic wedge is operable for exerting an outwardly perpendicular wedging force on the plurality of permanent magnets for preventing their lateral movement within the rotor slots.

In one embodiment, the bulbous shaped portions are operable for reducing the magnetic leakage from the plurality of permanent magnets through rotor material located between the plurality of permanent magnets and a stator, improving d-axis flux, and for reducing stress levels exerted upon the rotor material located between the plurality of permanent magnets and the stator.

In one embodiment, an electric machine includes but is not limited to a rotor core having a magnet slot and further having at least one non-magnetic structure formed at a rotor core internal location proximate to an expected pole location of a magnet emplaced in the magnet slot.

In one embodiment, a method for use with an electric machine includes but is not limited to rotating a rotor having at least one non-magnetic structure formed at a rotor core internal location proximate to an expected pole location of a magnet emplaced in a magnet slot.

In one embodiment, a method for use with an electric machine includes but is not limited to rotating a rotor having at least one load absorbing structure interposed between a magnet slot and a rotor core material.

In one embodiment, a method for use with an electric machine includes but is not limited to disposing a permanent magnet into a slot of a rotor lamination stack, wherein the slot comprises a trapezoidal shaped (e.g., rectangular shaped) portion and bulbous shaped portions disposed at both ends of the trapezoidal shaped (e.g., rectangular shaped) portion, and wherein the slot further comprises at least one notch disposed at the points where the trapezoidal shaped (e.g., rectangular shaped) portion and the bulbous shaped portions meet; inserting a non-magnetic wedge adjacent to the permanent magnet; and inserting a filler into the bulbous shaped portions.

In one embodiment, a rotor assembly of an electric machine includes but is not limited to a lamination layer configured to be axially stacked in a series of lamination layers to form a rotor core of an electric machine; the lamination layer forming at least a part of at least one internal slot, each internal slot comprising an elongate portion and at least one expanded end portion disposed at one end of the elongate portion; and a permanent magnet disposed within each internal slot.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the devices and/or processes described herein, as defined solely by the claims, will become apparent in the non-limiting detailed description set forth herein.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1A is a cross-sectional view of an electric machine assembly showing a stator and rotor core according to one illustrated embodiment.

FIG. 1B is a cross-sectional view of an electric machine assembly showing a rotor lamination layer which includes a permanent magnet disposed within a rotor slot.

FIG. 2 is a cross-sectional view of an electric machine assembly showing a rotor lamination layer that includes a permanent magnet disposed within a rotor slot and having a filler disposed within the balance of the rotor slot.

FIG. 3 is a front-plan view of a conventional rotor lamination layer indicating the stress forces created during high speed machine operation (rotation).

FIG. 4 is a front-plan view of a rotor lamination layer indicating the stress forces created during high speed machine operation.

FIG. 5 shows a stress analysis diagram of a portion of an electric machine such as those shown and described elsewhere herein, but wherein no epoxy filler has been deposed.

FIG. 6 shows a stress analysis diagram of a portion of an electric machine such as those shown and described elsewhere herein, but wherein epoxy filler has been deposed.

### DETAILED DESCRIPTION OF THE INVENTION

As required, detailed embodiments of the present systems and methods are disclosed herein, however, it is to be understood that the disclosed embodiments are merely exemplary of the systems and methods that may be embodied in various and alternative forms. Specific structural and functional details disclosed herein are not to be interpreted as limiting, but merely as a basis for the claims and as a representative basis for teaching one skilled in the art to variously employ the present systems and methods.

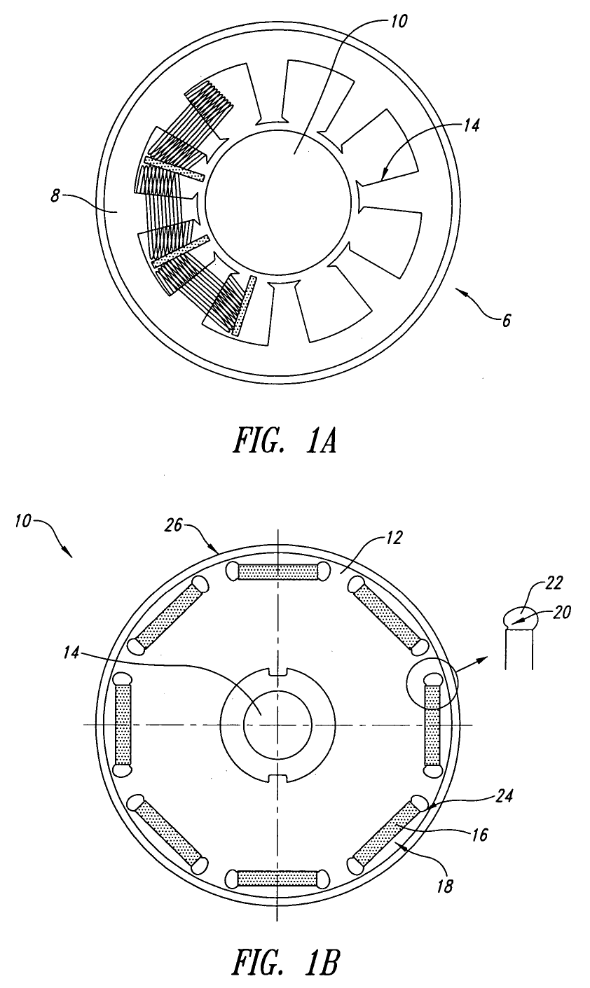

Referring now to the drawings, in which like numerals indicate like components throughout the several figures, FIG. 1A shows an electric machine 6 comprising a stator 8 and rotor core 10, according to one illustrated embodiment. FIG. 1B shows the rotor core 10 comprising a rotor lamination 12 disposed around a rotor shaft 14. A banding material 26 about 0.08 inches (2 mm) in thickness is disposed around the outer perimeter of the rotor core 10. In one embodiment, the rotor core 10 includes a plurality (more than one) of laminations 12 stacked together axially along a longitudinal axis of the rotor 10 to form a lamination stack. Permanent magnets 16 are received through aligned openings, or slots 18, which are through holes whose shape is defined by the permanent magnet 16 structure. The permanent magnets 16 are disposed in physically separate trapezoidal shaped (e.g., rectangular shaped) slots 18. The retention of the permanent magnets 16 is achieved in part by a notch 20 located on either side of the trapezoidal portion of the slot 18. A bulbous shaped cavity 22 is formed at both ends of the slot 18 and is designed to reduce the magnetic leakage path, improve the d-axis flux, and reduce the stress levels placed on the rotor lamination 12 during high speed synchronous machine operation.

In a further aspect, a non-magnetic wedge 24 is inserted adjacent to the permanent magnet 16 to securely retain the permanent magnet 16 in its desired position. The non-magnetic wedge 24 may be inserted to prevent lateral movement of the permanent magnet 16 which may cause structural damage to the permanent magnet 16 during the high speed operation of the synchronous machine. The non-magnetic wedge 24 provides a perpendicular wedging force on the permanent magnet 16. By securely wedging at least one face of the magnet 16 against at least one wall of its designated slot 18, the permanent magnet is prevented from moving in a forwards, backwards, or lateral direction.

In the preferred embodiment, at least one notch 20 is disposed on the rotor lamination 12 essentially at the locations where the trapezoidal shaped (e.g., rectangular shaped) portion of the slot and a bulbous shaped portion of the slot meet. The notch 20 is operable for (used for) ensuring that there is no lateral movement of the permanent magnet 16 within the slot. Lateral movement during high speed machine operation may lead to structural damage of the magnet 16, that in turn may lead to decreased machine performance. The notch 20 consists of a small piece of the lamination 12 material extending into the slot 18, and creating a separation of the trapezoidal shaped (e.g., rectangular shaped) portion and bulbous shaped portions of the rotor slot 18. A permanent magnet 16 may be inserted into a rotor slot 18 and held in place by a plurality of notches 20. In one embodiment, the present systems and methods consist of a rotor lamination 12 including two notches, each of which is disposed on a side of the trapezoidal shaped (e.g., rectangular shaped) portion thereby preventing lateral movement within the slot. In an alternative embodiment, the present systems and methods consist of a rotor Lamination 12 including four notches, with each notch being disposed at a corner of the permanent magnet 16. The plurality of notches provides perpendicular wedging forces on the permanent magnet 16.

Referring to FIG. 2, in one embodiment, a filler 30 may be disposed within the bulbous shaped portions of the rotor slots 18 (as seen in FIG. 1B). In an alternative embodiment, the filler 30 may be disposed within the bulbous shaped portions of the rotor slot 18 and also in the trapezoidal shaped (e.g., rectangular shaped) portion along with the permanent magnet 16. The filler 30 may include a non-magnetic material such as air, an epoxy, a resin, and/or an adhesive.

An epoxy, resin, and/or adhesive may be additionally used to firmly fix the permanent magnet 16 within the permanent magnet's 16 designated rotor slot 18. Still further, the fixative (epoxy, resin, and/or adhesive) may firmly secure the permanent magnet 16 to the notches 20 and to the non-magnetic wedge 24. The filler 30 may also be used in a curative manner to fill gap spaces resulting from deviations in the form of a particular permanent magnet. A further benefit of using such a filler 30 is that its completion of the filling of the rotor slot 18 strengthens the physical structure of the rotor lamination 12. A weakening of the physical structure of the rotor lamination 12 is a direct result of the cutting away of a rotor slot 18, which is operable for receiving a permanent magnet 16. By adding the filler 30 after inserting the permanent magnet 16 into the rotor slot 18, structural integrity is restored to the rotor lamination 12.

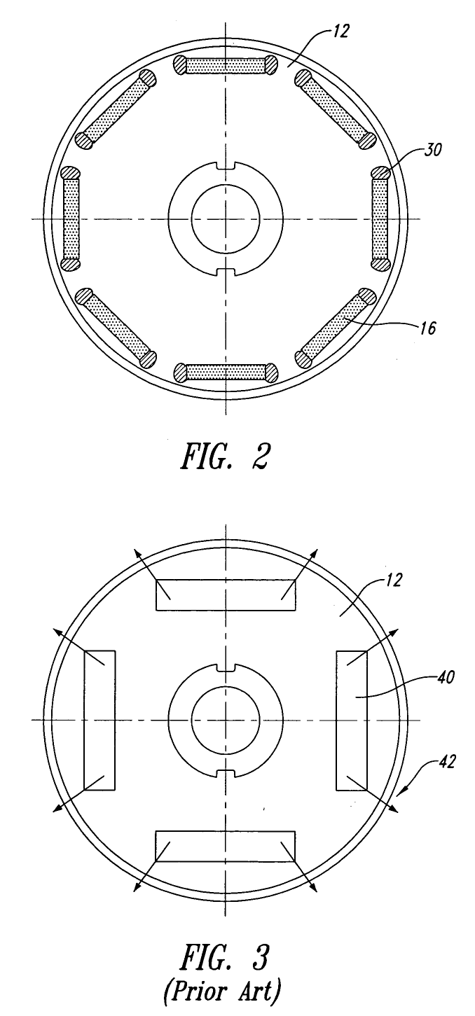

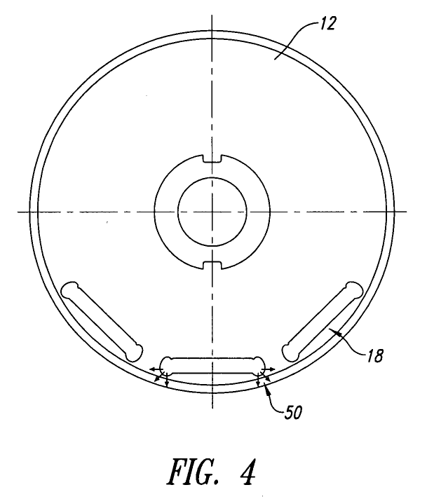

The bulbous shaped portion of the rotor slot 18 is operable for reducing the stress levels placed on the rotor lamination 12 during very high operating speeds of the synchronous machine. Referring to FIG. 3, a conventional rotor lamination design is shown in which rotor slots are rectangularly shaped 40 and result in very high stress levels 42 at the corners of the rotor slots. These high stress levels may result in structural damage to the rotor laminations that may lead to machine failure. Referring to FIG. 4, the rotor slot 18 design of the present systems and methods greatly reduce the very high stress levels 50 placed upon the rotor laminations 12. By having a slot 18 consisting of a bulbous shaped portion at each end of the slot 18, and wherein the bulbous shape is predominantly rounded or circular in shape, the present systems and methods allow the synchronous machine to be run at higher operating speeds, as well as longer continuous operating intervals without damaging the physical structure of the rotor laminations 12.

The high stress forces placed on the rotor material disposed between the permanent magnet 12 and the stator are distributed over a greater surface area due to the circular shaped structure of the rotor slots 18 of the present systems and methods. In conventional lamination designs, a high amount of stress is directed towards the outer corners of the rotor slot due to the centrifugal forces of the permanent magnet 16 generated during high speed machine operation.

In the present systems and methods, extensive structural stress analysis was used to improve the design of the rotor lamination, while magnetic flux analysis was performed to optimize the synchronous machine's magnetic circuit. Magnetic flux is defined as the magnetic lines of force produced by a magnet. Magnetic leakage is defined as the passage of magnetic flux outside the path along which it can do useful work.

The bulbous shaped portions of the rotor slot 18 are designed to reduce the magnetic leakage path and improve d-axis flux characteristics. The bulbous shaped openings prevent magnetic leakage paths from emerging at the outer periphery of the rotor core 10. The lamination material disposed between the permanent magnet 16 and the stator has been minimized by the bulbous shaped portion design so that saturation occurs. Saturation limits the flux magnitude. Different materials saturate at different values of flux density. At the saturation point, the inductance is very small. The bulbous shaped portion, which increases the structural strength of the rotor lamination 12, allows for the minimizing of the lamination material disposed between the permanent magnet 16 and the stator. The rotor lamination 12 core material serves as a secure anchor for the permanent magnets 16 while also providing the desired magnetic behavior. By minimizing the lamination material disposed between the permanent magnet 16 and the stator, and in effect disposing the permanent magnets 16 closer to the stator, the rotor lamination 12 design of the present systems and methods allow for a decrease in the amount of permanent magnet 16 material used. This is particularly beneficial in that the material that makes up the permanent magnet is one of the more costly components of a synchronous machine. Disposing the permanent magnets 16 closer to the stator results in a reduction in the magnetic leakage path that in turn results in an increase in the amount of work that an electric machine is able to perform.

Although the shape of the rotor slots 18 has been described above, the shape of a permanent magnet 16 may be arbitrarily determined because there is a sufficient degree of freedom in the forming of permanent magnets. The shape of a rotor slot may vary while still maintaining the general functioning described above. Also, the arrangement patterns of the permanent magnets 16 are only examples and not limitations to what are possible configurations according to the present systems and methods.

As noted above, extensive structural stress analysis was used to improve the design of the rotor lamination, while magnetic flux analysis was performed to optimize the synchronous machine's magnetic circuit.

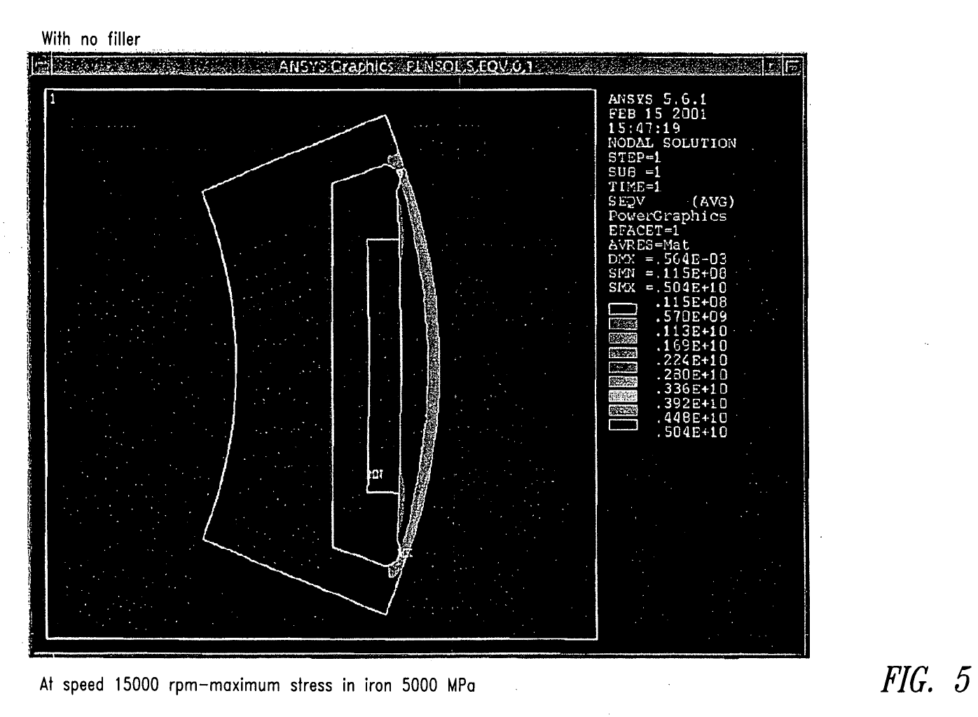

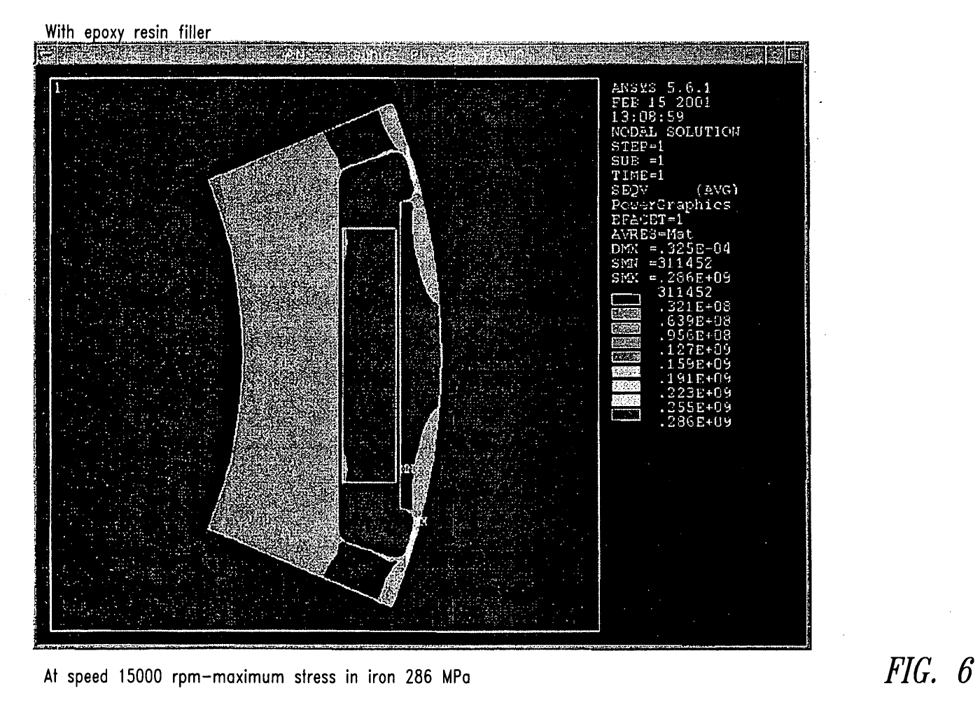

Referring now to FIG. 5, shown is a stress analysis diagram of a portion of an electric machine such as those shown and described elsewhere herein, but wherein no epoxy filler has been deposed. It is to be understood that the diagram shown is a stress analysis diagram and is consequently showing stress patterns. Depicted is that when a rotor core having a permanent magnet and a magnet slot wherein a permanent magnet is emplaced is rotated at 15000 rpm, up to 5000 MPa (mega-Pascals) of stress are generated in stress-affected portions of the iron rotor core.

Referring now to FIG. 6, shown is a stress analysis diagram of a portion of an electric machine such as those shown and described elsewhere herein, but wherein epoxy filler has been deposed. It is to be understood that the diagram shown is a stress analysis diagram and is consequently showing stress patterns. Depicted is that when a rotor core having a permanent magnet and a magnet slot wherein a permanent magnet is emplaced is rotated at 15000 rpm, up to 286 MPa (mega-Pascals) of stress are generated in stress-affected portions of the iron rotor core.

Comparison of the stress patterns and maximum stresses shown in FIGS. 5 and 6 show that the introduction of the epoxy filler results in significant stress reduction beyond that possible in the absence of such filler. In addition to the foregoing, while not explicitly shown, it is to be understood that the structures shown and described herein offer stress reduction over and above that available in the related art, even in the absence of the above-described epoxy filler. However, as has been demonstrated above, the use of the epoxy filler, in some embodiments, actually increases the stress reduction achieved.

Various embodiments of the present systems and methods have been described herein. It should be recognized, however, that these embodiments are merely illustrative of the principles of the present systems and methods. Numerous modifications and adaptations thereof will be apparent to those skilled in the art without departing from the spirit and scope of the present systems and methods.

All of the above U.S. patents, U.S. patent application publications, U.S. patent applications, foreign patents, foreign patent applications and non-patent publications referred to in this specification and/or listed in the Application Data Sheet, including but not limited to U.S. Provisional Application Ser. No. 60/432,727, filed Dec. 11, 2002, and entitled “ROTOR ASSEMBLY OF SYNCHRONOUS MACHINE,” are incorporated herein by reference, in their entirety.

1. An electric machine, comprising:
a stator; and
a rotor core mounted for rotation with respect to the stator, the rotor core comprising a number of magnet slots and at least one non-magnetic structure formed at a rotor core internal location proximate to an expected pole location of a magnet emplaced in the magnet slot.

2. The electric machine of claim 1 wherein each of the magnet slots comprises a portion having a shape complimentary to a shape of at least a portion of the magnet.

3. The electric machine of claim 2 wherein the portion of the magnet slot having the complimentary shape is elongated.

4. The electric machine of claim 1 wherein the at least one non-magnetic structure formed at a rotor core internal location proximate to an expected pole location of a magnet emplaced in the magnet slot comprises an end of the magnet slot abutting at least one non-magnetic region having a width in excess of a width of the magnet slot where at least a portion of the magnetic slot is substantially magnet-shaped.

5. The electric machine of claim 4 wherein the at least one non-magnetic region having a width in excess of a width of the magnet slot comprises a substantially bulbous region.

6. The electric machine of claim 1 wherein each of the magnet slots further comprises:
at least one notch disposed substantially along a side of the respective ones of the magnet slots.

7. The electric machine of claim 1 wherein the at least one non-magnetic structure formed at a rotor core internal location proximate to an expected pole location of a magnet emplaced in the magnet slot further comprises:
a filler forming at least a part of the at least one non-magnetic structure.

8. The electric machine of claim 7, wherein the filler comprises at least one of air, an epoxy, a resin, and an adhesive.

9. The electric machine of claim 1, further comprising:
a number of permanent magnets, each of the permanent magnets disposed within a respective one of the magnet slots.

10. The electric machine of claim 9, further comprising:
a filler disposed within the magnet slots.

11. The electric machine of claim 9, further comprising:
a number of non-magnetic wedges, each non-magnetic wedge disposed adjacent to a respective one of the permanent magnets to establish a movement-resistant friction fit between the permanent magnet and the magnet slot.

12. An electric machine, comprising:
a stator;
a rotor mounted for rotation with respect to the stator, the rotor comprising a number of magnet slots, each slot comprising opposed end portions and a central portion disposed between the end portions, the central portion of each of the magnet slots shaped to complimentarily receive a magnet; and
a number of magnets complimentarily received in the central portions of the magnet slots of the rotor.

13. The electric machine of claim 12, further comprising:
a filler received in the end portions of the magnet slots.

14. The electric machine of claim 13 wherein the filler is selected from the group consisting of least one of air, an epoxy, a resin, and an adhesive.

15. The electric machine of claim 12, further comprising:
a load absorbing material filling at least a portion of each of the end portions of the magnet slots.

16. The electric machine of claim 12, wherein the end portions the magnet slots have a width greater than a width of the central portion of the magnet slots.

17. The electric machine of claim 12, wherein the end portions of the magnet slots are substantially bulbous-shaped.

18. A method for use with an electric machine, comprising:
rotating a rotor having at least one load absorbing structure interposed between a magnet slot and a rotor core material.

19. The method of claim 18, wherein the at least one load absorbing structure interposed between a magnet slot and a rotor core material comprises at least one of air, epoxy, resin, and adhesive.

20. The method of claim 18, wherein the at least one load absorbing structure further comprises a bulbous portion.

21. The method of claim 18, wherein the at least one load absorbing structure further comprises:
the magnet slot formed contiguous with the at least one load absorbing structure.

22. A method of forming an electric machine, comprising:
providing a number of rotor laminations each having a number of slots, wherein the slots comprise a trapezoidal shaped portion and bulbous shaped portions disposed at both ends of the trapezoidal shaped portion, and wherein the slots further comprise at least one notch disposed at points where the trapezoidal shaped portion and the bulbous shaped portions meet;
laminating the rotor laminations to form a rotor lamination stack;
disposing a respective one of a number of permanent magnets into each of the slots of the rotor lamination stack;
inserting a non-magnetic wedge adjacent to the permanent magnets;
inserting a filler into the bulbous shaped portions of each of the slots; and
mounting the rotor lamination stack for rotation with respect to a stator.

23. The method of claim 22 wherein inserting a filler into the bulbous shaped portions comprises inserting at least one of air, epoxy, resin, and adhesive.

24. The method of claim 22 further comprising:
positioning the bulbous shaped portions to reduce magnetic leakage from the permanent magnets through a rotor material located exteriorly to the permanent magnets.

25. The method of claim 22, further comprising:
configuring the at least one notch to exert a wedging force on the respective one of the permanent magnets and thereby prevent the permanent magnet from moving within the respective one of the slots.

26. A rotor assembly of an electric machine, comprising:
a lamination layer configured to be axially stacked in a series of lamination layers to form a rotor core of an electric machine;
the lamination layer forming at least a part of at least one internal slot, each internal slot comprising an elongate portion and at least one expanded end portion disposed at one end of the elongate portion; and
a permanent magnet disposed within each internal slot.
